(19) United States
(12) Patent Application Publication
(10) Pub. No.: US 2003/0231139 A1
(43) Pub. Date: Dec. 18, 2003

(54) Wide band antenna

(76) Inventors: Lung-Sheng Tai, Tu-Chen (TW); Lin Hsien Chu, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/299,205

(22) Filed: Nov. 18, 2002

(30) Foreign Application Priority Data
Jun. 13, 2002 (TW) 091208817

(51) Int. Cl. H01Q 9/28

(52) U.S. Cl. 343/795

(57) ABSTRACT

A wide band antenna (1) includes a printed circuit board (2), a dipole (6) mounted on the printed circuit board and a feeder apparatus (5) through which the dipole is fed. The dipole includes a first pole (3) and a second pole (4) spaced apart from the first pole. The first pole forms a middle portion (33), a first portion (31), and a second portion (32), and the first and the second portions respectively extend rearwardly from two opposite ends of the middle portion. A length of the first portion differs from a length of the second portion. The second pole is a bar microstrip adjacent to the middle portion, but a gap is formed therebetween. The first portion and the second portion can separately transfer signals, to allow the antenna to operate in two different wide band frequency bands.

### BACKGROUND OF THE INVENTION

1. Field of the Invention

The present invention relates to wide band antennas, and particularly to a dipole microstrip wide band antenna used in an electronic device for wireless transmission.

2. Related Art

Wireless LAN currently has four standards, which include IEEE802.11, IEEE802b, and Bluetooth in the 2.4 GHz frequency band, and IEEE802.11a in the 5 GHz frequency band. Antennas, which satisfy more than one standard are available for wireless electronic devices working in multiple frequency bands. However, conventional single dipole antennas can only be used in a narrow frequency band, and are usually limited to mono-frequency use so do not satisfy the above mentioned needs.

Such a conventional antenna is disclosed in China Pat. No. 01,224,549. The antenna has a substrate, and an upper metal layer and a lower metal layer printed on two opposite surfaces of the substrate. The upper metal layer forms a signal feed conductive strip, and a quarter wavelength radiation conductive strip extending from the signal feed conductive strip. The lower metal layer includes a grounding conductor and two quarter wavelength radiation conductive strips extending from the grounding conductor. The radiation conductive strip of the upper metal layer and the two radiation conductive strips of the lower metal layer act together as a dipole to achieve antenna radiation. However, this antenna can only be used in a single frequency band, which is 2.4-2.5 GHz in the embodiment described.

Another prior art antenna is disclosed in U.S. Pat. No. 5,598,174, and it can also only be used in a frequency band.

Accordingly, an improved antenna is desired to overcome the above problems.

### SUMMARY OF THE INVENTION

An object of the present invention is to provide a wide band antenna which can be used in different frequency bands.

To achieve the above object, a wide band antenna in accordance with a preferred embodiment of the present invention includes a printed circuit board, a dipole mounted on the printed circuit board, and a feeder apparatus through which the dipole is fed. The dipole includes a first pole and a second pole spaced apart from the first pole. The first pole forms a middle portion, a first portion, and a second portion, and the first and the second portions respectively extend rearwardly from two opposite ends of the middle portion. A length of the first portion differs from a length of the second portion. The second pole is a bar microstrip adjacent to the middle portion, a gap being maintained therebetween. The first portion and the second portion can each transfer signals, to allow the antenna to operate in two different wide band frequency bands.

These and additional object, features and advantages of the present invention will become apparent after reading the following detailed description of a preferred embodiment of the invention taken in conjunction with the appended drawings.

### BRIEF DESCRIPTION OF THE DRAWINGS

FIG. 1 is a plan view of a wide band antenna according to a preferred embodiment of the present invention;

FIG. 2 is an orientation schematic diagram of the wide band antenna of FIG. 1 in an XYZ coordinate system;

FIG. 3 is a graph of experimental results for VSWR of the wide band antenna of FIG. 1, using coordinate system shown in FIG. 2;

FIG. 4 is a horizontal radiation graph in an XY-plane of the wide band antenna of FIG. 1 located in the coordinate system of FIG. 2 in the 2.4-2.5 GHz frequency band;

FIG. 5 is a vertical radiation graph in the XY-plane of the wide band antenna of FIG. 1 located in the coordinate system of FIG. 2 in the 2.4-2.5 GHz frequency band;

FIG. 6 is a horizontal radiation graph in the XY-plane of the wide band antenna of FIG. 1 located in the coordinate system of FIG. 2 in the 5.15-5.35 GHz frequency band;

FIG. 7 is a vertical radiation graph in the XY-plane of the wide band antenna of FIG. 1 located in the coordinate system of FIG. 2 in the 5.15-5.35 GHz frequency band;

FIG. 8 is a table of describing the gain characteristic of the wide band antenna of FIG. 1, using the coordinate system of FIG. 2;

FIG. 9 is another orientation schematic diagram of the wide band antenna of FIG. 1 in a different XYZ coordination system;

FIG. 10 is similar to FIG. 3, but using the coordinate system of FIG. 9;

FIG. 11 is similar to FIG. 4, but using the coordinate system of FIG. 9;

FIG. 12 is similar to FIG. 5, but using the coordinate system of FIG. 9;

FIG. 13 is similar to FIG. 6, but using the coordinate system of FIG. 9;

FIG. 14 is similar to FIG. 7, but using the coordinate system of FIG. 9; and

FIG. 15 is similar to FIG. 8, but using the coordinate system of FIG. 9.

### DETAILED DESCRIPTION OF THE INVENTION

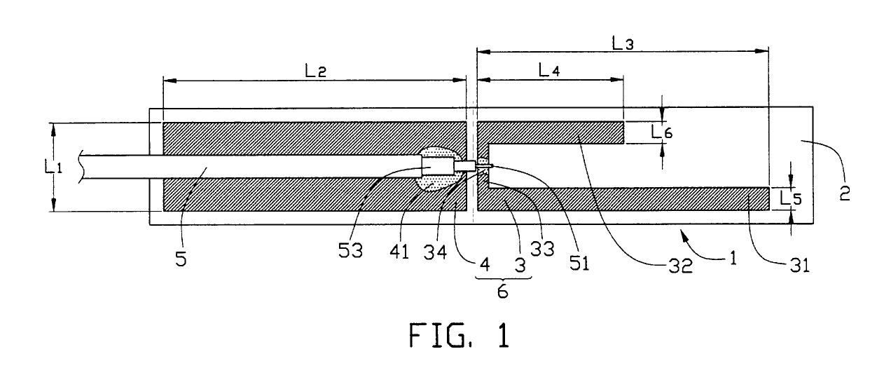

Referring to FIG. 1, a wide band antenna 1 in accordance with a preferred embodiment of the present invention is a dipole microstrip wide band antenna, and includes a printed circuit board (PCB) 2, a dipole 6 and a feeder apparatus 5.

The dipole 6 is formed on a surface of the PCB 2, and includes a first pole 3 and a second pole 4 opposite to the first pole 3. The first pole 3 has approximately the shape of the letter n, and forms a middle portion 33, a first portion 31, and a second portion 32, and the first and the second portions 32 extend rearwardly from two opposite ends of the middle portion 33. The middle portion 33 defines a first feed point 34 in a center thereof. The first portion 31 and the second portion 32 can receive or transmit signals. A length of the first portion 31 is greater than a length of the second portion 32, so that the first portion 31 allows the antenna 1 to operate in a low frequency band, and the second portion 32 allows the antenna 1 to operate in a high frequency band. The operating frequencies are determined by these lengths of the first portion 31 and the second portion 32. Breadths of the first portion 31 and the second portion 32 determine bandwidth at the associated frequency. So tuning the lengths and the breadths of the first portion and the second portion of the first pole allows the wide band antenna 1 to operate in different frequencies and frequency bands.

The second pole 4 is an integral bar microstrip which is disposed opposite to the middle portion 33 of the first pole, with a gap therebetween. One end of the second pole 4, adjacent to the first pole 3, forms a second feed point 41 thereon.

In this preferred embodiment, the feeder apparatus 5 is a coaxial cable, which includes a central conductor 51 and a braiding layer 53 surrounding the central conductor 51. The central conductor 51 serves as a signal feed and connects to the first feed point 34. The braiding layer 53 serves as a grounded shield and connects with the second feed point 41. The feeder apparatus 5 feeds the dipole 6 through the first feed point 34 and the second feed point 41.

In this preferred embodiment, the first pole 3 and the second pole 4 are located on the same surface of the PCB 1, but they can alternatively be located on different surfaces of the PCB 1. Moreover, the PCB can be a flexible PCB or an inflexible PCB.

The dimensions of the antenna elements are chosen to satisfy different needs. L1, L5 and L6 shown in FIG. 1 respectively designate breadths of the second pole 4 and the first and the second portions 31 and 32 of the first pole 3. L2, L3 and L4 respectively designate lengths of the second pole 4 and the first and the second portions 31 and 32 of the first pole 3. A length of the middle portion 33 of the first pole 3 is also L1, and its breadth is equal to or smaller than L5.

The structural dimensions of the preferred embodiment of the invention are as follows: L1=8.00 mm, L2=27.20 mm, L3=25.20 mm, L4=12.15 mm and L5=L6=2.00 mm. These dimensions allow the antenna 1 to operate in two wide band frequency bands, one of which is 2.4-2.5 GHz, and another of which is 5.15-5.35 GHz.

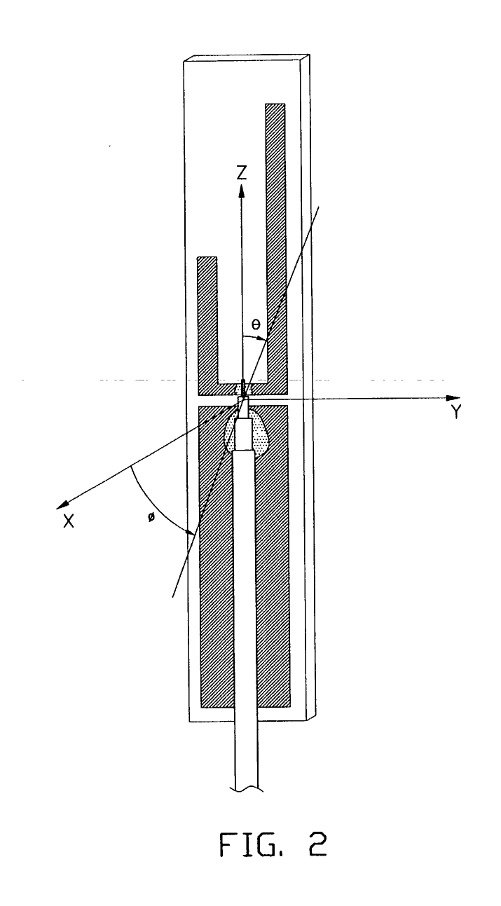

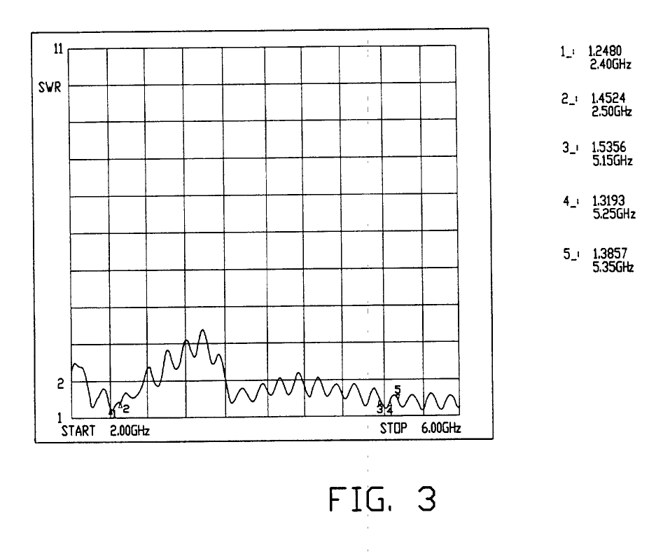

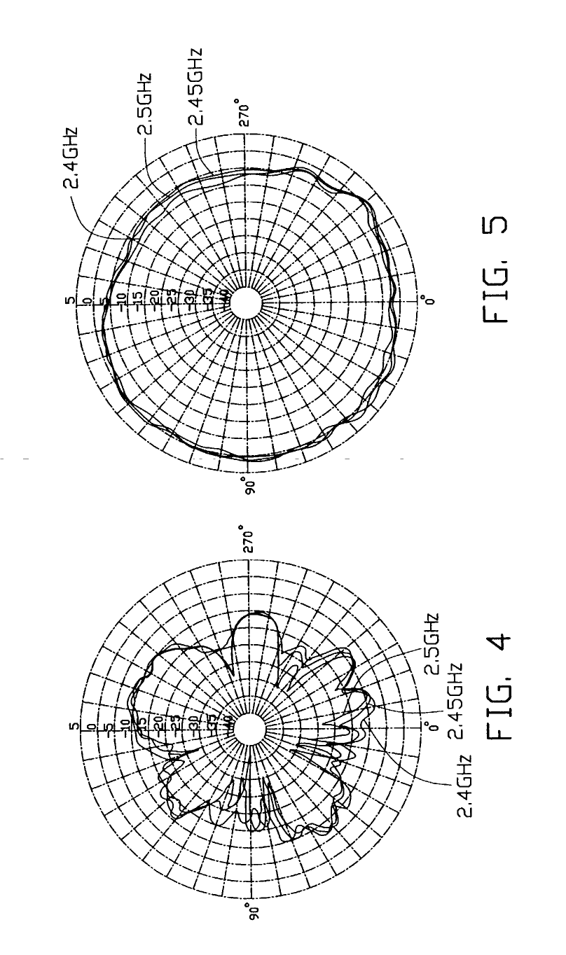

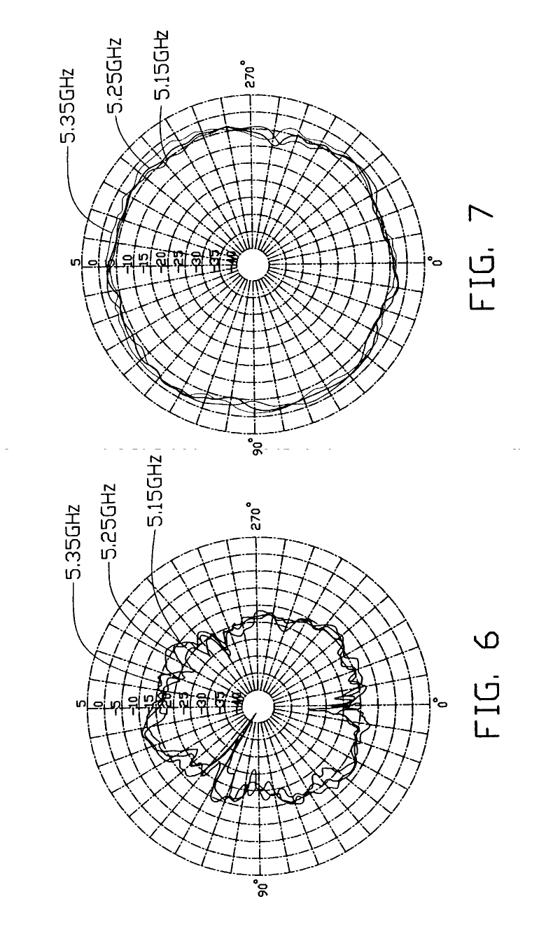

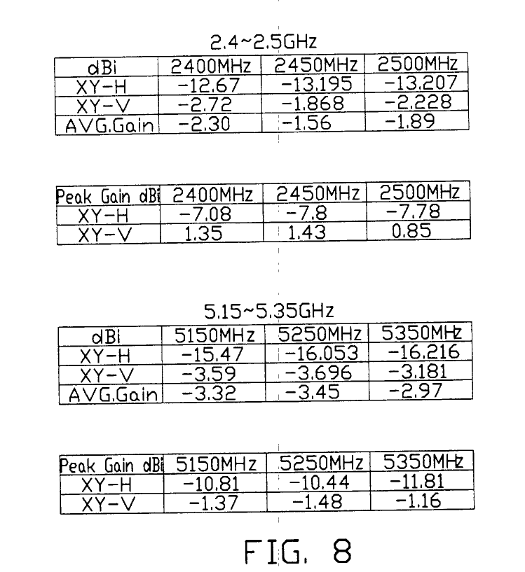

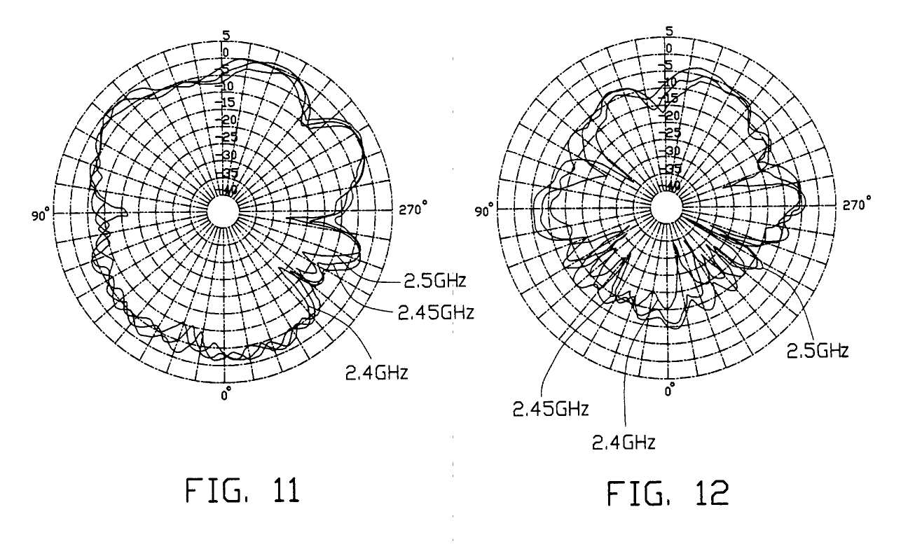

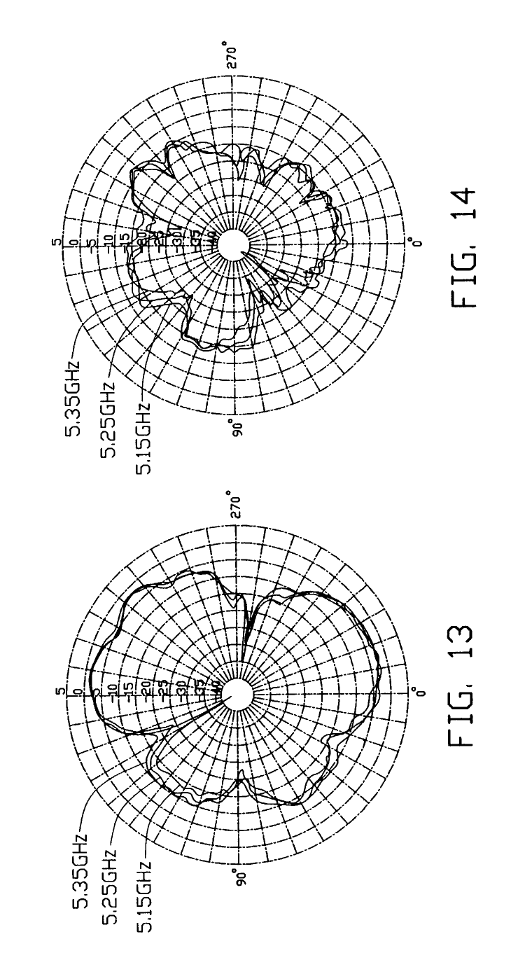

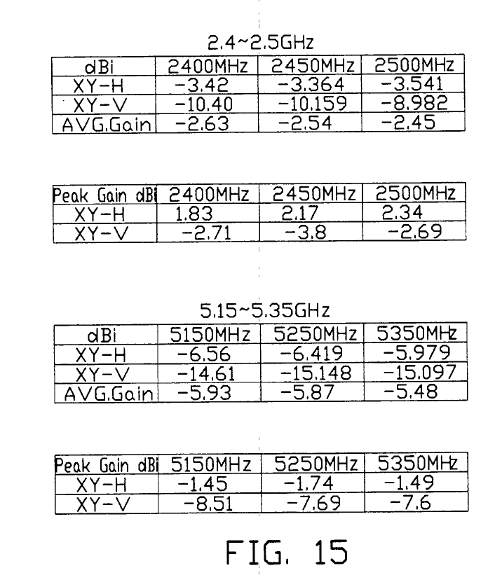

FIGS. 2-15 show basic performance measures of the preferred embodiment wide band antenna 1 having the dimensions detailed in the paragraph above. Firstly referring to FIGS. 2-8, FIG. 2 defines an orientation in an XYZ coordinate system of the antenna 1 for measured values graphed and tabled in FIGS. 3-8. FIG. 3 is a graph of measured values showing VSWR of the wide band antenna 1 varying with frequency. The results show that the VSWR are all less than 2.0 in the frequency ranges of 2.4(point 1)-2.5(point 2) GHz and 5.15(point 3)-5.35(point 5) GHz and thus comply with industry-standard antenna design specifications. FIG. 4 and FIG. 5 respectively show a horizontal and a vertical radiation graphs in the XY-plane of the wide band antenna 1 in the frequency band 2.4-2.5 GHz. The values were measured for the three frequencies 2.4 GHz, 2.45 GHz and 2.5 GHz. FIG. 6 and FIG. 7 respectively show a horizontal and a vertical radiation graphs in the XY-plane of the wide band antenna 1 in the frequency band 5.15-5.35 GHz. The values were measured for the three frequencies 5.15 GHz, 5.25 GHz and 5.35 GHz. These graphs show that the wide band antenna 1 has optimum diversity radiation efficiency. FIG. 8 shows measured gain characteristics of the wide band antenna 1; the results shown comply with industry-standard antenna design specifications.

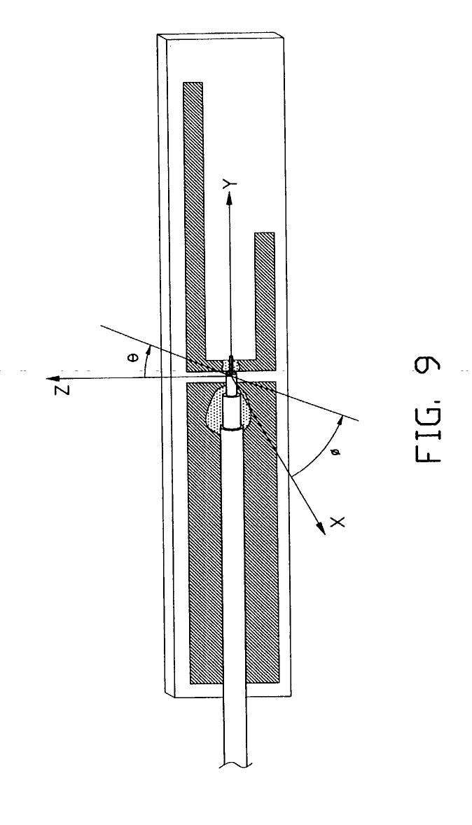

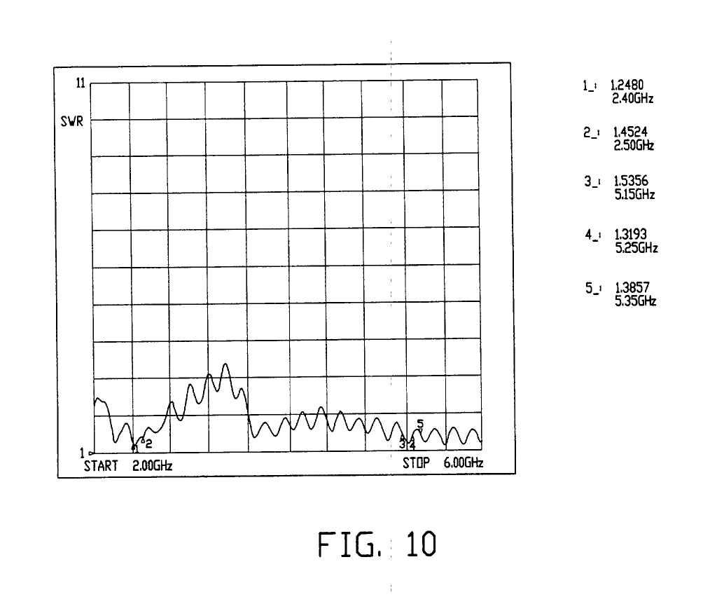

Next referring to FIGS. 9-15, FIG. 9 defines another orientation in an XYZ coordinate system of the antenna 1 for measured values graphed and tabled in FIGS. 10-15. FIGS. 10-15 respectively correspond to FIGS. 3-8, but under the different reference coordinates. Measured values graphed and tabled in FIGS. 10-15 also comply with industry-standard antenna design specifications.

In comparison with the prior art, this present invention can be used in either or both of two different wide band frequency bands, so it can be used in wireless electronic devices operable under either of two frequency band standards.

Although the present invention has been described with reference to a specific embodiment thereof, the description is illustrative and is not to be construed as limiting the invention. Various modifications to the present invention may be made to the preferred embodiment by those skilled in the art without departing from the true spirit and scope of the invention as defined by the appended claims.

I claim:

1. A wide band antenna, comprising:
a printed circuit board;
a dipole mounted on the printed circuit board, the dipole including a first pole and a second pole spaced apart from the first pole, the first pole forming a middle portion, a first portion, and a second portion, with the first and the second portions respectively extending rearwardly from two ends of the middle portion, a length of the first portion differing from a length of the second portion; and
a feeder apparatus through which the dipole is fed; wherein
the first portion and the second portion transfer signals respectively in two different wide band frequency bands.

2. The wide band antenna as claimed in claim 1, wherein the first pole has approximately the shape of the letter n.

3. The wide band antenna as claimed in claim 1, wherein the first pole forms a first feed point thereon between a free end of the first portion and a free end of the second portion.

4. The wide band antenna as claimed in claim 3, wherein the first pole forms a first feed point on the middle portion thereof, and the second pole forms a second feed point on one end thereof, adjacent to the first pole, and the feeder apparatus feeds the dipole through the first and the second feed points.

5. The wide band antenna as claimed in claim 1, wherein the length of the first portion is greater than the length of the second portion, whereby the first portion and the second portion allow the wide band antenna to operate in a low frequency band and in a high frequency band, respectively.

6. The wide band antenna as claimed in claim 1, wherein tuning the lengths of the first portion and the second portion of the first pole allows the wide band antenna to operate in different frequencies.

7. The wide band antenna as claimed in claim 1, wherein tuning the breadths of the first portion and the second portion of the first pole allows the wide band antenna to operate in different frequency bands.

8. The wide band antenna as claimed in claim 1, wherein the second pole is a bar microstrip.

9. The wide band antenna as claimed in claim 1, wherein the second pole is adjacent to the middle portion of the first pole and a gap is formed therebetween.

10. The wide band antenna as claimed in claim 1, wherein the first pole and the second pole are mounted on a same surface of the printed circuit board.

11. The wide band antenna as claimed in claim 1, wherein the first pole and the second pole are respectively mounted on two opposite surfaces of the printed circuit board.

12. The wide band antenna as claimed in claim 4, wherein the feeder apparatus is a coaxial feeder having a signal feed and a grounded shield which respectively connect with the first and the second feed points.

13. A wide band antenna comprising:
a printed circuit board defining a lengthwise direction and a lateral direction perpendicular to each other;
a dipole formed on a surface of the printed circuit board and including spaced first and second pole regions arranged along the lengthwise direction, said first pole region and said second pole region having similar dimensions along both said lengthwise direction and said lateral dimension;
a grounding pad formed on the second pole region with full dimensions therewith in said lengthwise and lateral directions;
a strip like middle portion formed on the first pole region adjacent to the second pole region and extending in the lateral direction and having a dimension similar to that of the grounding pad along said lateral direction;
parallel first and second strip like portions extending in said lengthwise direction from two opposite ends of middle portion and opposite to said grounding pad; wherein
said first and second portions have different dimensions in said lengthwise direction, and the dimension of one of said first and second portions in said lengthwise direction is similar to that of the grounding pad.

14. The antenna as claimed in claim 13, wherein said a feeder cable has an outer grounding braid soldered on the grounding pad close to the middle portion, and an inner conductive core soldered on the middle portion.

15. The antenna as claimed in claim 13, wherein said first portion and said second portion have similar dimensions in said lateral direction.
